(19) United States
(12) Patent Application Publication
(10) Pub. No.: US 2014/0112287 A1
(43) Pub. Date: Apr. 24, 2014

(54) METHOD AND APPARATUS FOR ALLOCATING REFERENCE SIGNAL PORT IN WIRELESS COMMUNICATION SYSTEM

(71) Applicant: LG ELECTRONICS INC., Seoul (KR)

(72) Inventors: Jin Young Chun, Anyang-si (KR); Ki Tae Kim, Anyang-si (KR); Su Nam Kim, Anyang-si (KR); Ji Won Kang, Anyang-si (KR); Bin Chul Ihm, Anyang-si (KR); Sung Ho Park, Anyang-si (KR)

(73) Assignee: LG ELECTRONICS INC., Seoul (KR)

(21) Appl. No.: 14/126,388

(22) PCT Filed: Jun. 20, 2012
(86) PCT No.: PCT/KR2012/004874

§ 371 Date: Dec. 13, 2013

Related U.S. Application Data
(60) Provisional application No. 61/499,693, filed on Jun. 22, 2011.

(51) Int. Cl. H04L 5/00

(52) U.S. Cl. CPC H04L 5/0048
USPC 370/329

(57) ABSTRACT

Provided are a method and apparatus for allocating a DMRS (DeModulation Reference Signal) port in a wireless communication system. A base station: respectively allocates the DMRS port to a plurality of nodes by the number of layers used in each node; maps the DMRS port allocated to each node to a resource element within a RB (Resource Block); and transmits DMRS through the DMRS port allocated to each node. The plurality of nodes have the same cell ID (identifier) and the DMRS ports allocated to neighboring nodes in the plurality of nodes do not overlap each other.

### BACKGROUND OF THE INVENTION

1. Field of the Invention

The present invention relates to a wireless communications and more particularly, a method and apparatus for allocating a reference signal port in a wireless communication system including distributed multi-nodes.

2. Related Art

The next-generation multimedia wireless communication systems which are recently being actively researched are required to process and transmit various pieces of information, such as video and wireless data as well as the initial voice-centered services. The 4^{th} generation wireless communication systems which are now being developed subsequently to the 3^{rd} generation wireless communication systems are aiming at supporting high-speed data service of downlink 1 Gbps (Gigabits per second) and uplink 500 Mbps (Megabits per second). The object of the wireless communication system is to establish reliable communications between a number of users irrespective of their positions and mobility. However, a wireless channel has abnormal characteristics, such as path loss, noise, a fading phenomenon due to multi-path, inter-symbol interference (ISI), and the Doppler Effect resulting from the mobility of a user equipment. A variety of techniques are being developed in order to overcome the abnormal characteristics of the wireless channel and to increase the reliability of wireless communication.

Meanwhile, with the employment of machine-to-machine (M2M) communication and with the introduction and distribution of various devices such as a smart phone, a table personal computer (PC), etc., a data requirement size for a cellular network is increased rapidly. To satisfy a high data requirement size, various techniques are under development. A carrier aggregation (CA) technique, a cognitive radio (CR) technique, or the like for effectively using more frequency bands are under research. In addition, a multiple antenna technique, a multiple base station cooperation technique, or the like for increasing data capacity within a limited frequency are under research. That is, eventually, the wireless communication system will be evolved in a direction of increasing density of nodes capable of accessing to an area around a user. A wireless communication system having nodes with higher density can provide a higher performance through cooperation between the nodes. That is, a wireless communication system in which each node cooperates has a much higher performance than a wireless communication system in which each node operates as an independent base station (BS), advanced BS (ABS), node-B (NB), eNode-B (eNB), access point (AP), etc.

A distributed multi-node system (DMNS) comprising a plurality of nodes within a cell may be used to improve performance of a wireless communication system. The DMNS may include a distributed antenna system (DAS), a radio remote head (RRH), and so on. Also, standardization work is underway for various multiple-input multiple-output (MIMO) techniques and cooperative communication techniques already developed or applicable in a future so that they can be applied to the DMNS.

An antenna port for a demodulation reference signal (DMRS) is allocated to each of a plurality of nodes comprising a multi-node system (in what follows, the antenna port is called a DMRS port). It is required that a method for allocating DMRS ports in an efficient manner so that UEs connected to a neighboring node can avoid collision of DMRS ports.

### SUMMARY OF THE INVENTION

The present invention provides a method and apparatus for allocating a reference signal port in a wireless communication system. In a multi-node system including a plurality of nodes within one or more cells, the present invention provides a method for allocating DMRS ports to each of the plurality of nodes so that UEs connected to a neighboring node can avoid collision of DMRS ports. Also, the present invention provides a method for a UE to decode a physical downlink shared channel (PDSCH) or a new control channel through an allocated DMRS port.

In an aspect, a method for allocating, by a base station, a demodulation reference signal (DMRS) port in a wireless communication system is provided. The method includes allocating DMRS ports to each of a plurality of nodes by a number of layers used by each of the plurality of nodes, mapping the DMRS ports allocated to each of the plurality of nodes to resource elements within a resource block (RB), and transmitting a DMRS through the DMRS ports allocated to each of the plurality of nodes. The plurality of nodes have the same cell identifier (ID), and DMRS ports allocated to neighboring nodes among the plurality of nodes do not overlap with each other.

A DMRS port allocated to a first node among the plurality of nodes may be at least one DMRS port included in a first DMRS port set, and a DMRS port allocated to a second node, adjacent to the first node, among the plurality of nodes may be at least one DMRS port included in a second DMRS port set which do not overlap with the first DMRS port set.

The first DMRS port set may be any one of DMRS port sets {7, 8, 11, 13} and {9, 10, 12, 14}, and the second DMRS port set may be the remaining one of the DMRS port sets {7, 8, 11, 13} and {9, 10, 12, 14}.

The DMRS port allocated to the first node may be mapped to a first resource element set within the resource block, and the DMRS port allocated to the second node may be mapped to a second resource element set adjacent to the first resource element set within the resource block.

The second resource element set within the resource block of the first node and the first resource element set within the resource block of the second node may be used for transmission of data or in a null state.

DMRS ports allocated to one node among the plurality of nodes may be contiguous.

In another aspect, a method for receiving, by a user equipment (UE), a demodulation reference signal (DMRS) in a wireless communication system is provided. The method includes receiving DMRS port information from a base station, receiving a DMRS through at least one DMRS port allocated based on the received DMRS port information, and decoding a physical downlink shared channel (PDSCH) or a control channel within a data region based on the received DMRS.

The DMRS port information may include a DMRS port set, a start DMRS port within a selected DMRS port set, and the maximum number of layers.

The DMRS port information may include a start DMRS port and the maximum number of layers.

The DMRS port information may be a bitmap which specifies a DMRS port allocated to the UE by each bit.

The DMRS port information may be an index of one DMRS port.

The DMRS port information may be an arrangement order of DMRS ports.

The method may further include receiving scrambling identifier (SCID) information from the base station.

A control channel within the data region may be an enhanced physical downlink control channel (e-PDCCH) carrying a downlink control signal for a multi-node system or an enhanced physical control format indicator channel (e-PCFICH) carrying information about a region to which the e-PDCCH is allocated.

In another aspect, a user equipment (UE) configured to receive a demodulation reference signal (DMRS) in a wireless communication system is provided. The UE includes a radio frequency (RF) unit for transmitting or receiving a radio signal, and a processor connected to the RF unit, and configured to receive DMRS port information from a base station, receive a DMRS through at least one DMRS port allocated based on the received DMRS port information, and decode a physical downlink shared channel (PDSCH) or a control channel within a data region based on the received DMRS.

DMRS ports of neighboring nodes can be allocated without collision.

### BRIEF DESCRIPTION OF THE DRAWINGS

FIG. 1 shows a wireless communication system.

FIG. 2 shows a structure of a radio frame in 3GPP LTE.

FIG. 3 shows an example of a resource grid of a single downlink slot.

FIG. 4 shows a structure of a downlink subframe.

FIG. 5 shows a structure of an uplink subframe.

FIG. 6 shows an example of a multi-node system.

FIGS. 7 to 9 show examples of an RB to which a CRS is mapped.

FIG. 10 shows an example of an RB to which a DMRS is mapped.

FIG. 11 shows an example of an RB to which a CSI-RS is mapped.

FIG. 12 shows an example where a PCFICH, PDCCH, and PDSCH are mapped to a subframe.

FIG. 13 shows an example of resource allocation through an e-PDCCH.

FIG. 14 shows a pattern of which a DMRS is mapped within an RB briefly.

FIG. 15 shows an example of DMRS ports allocated to each node according to a proposed method for allocating DMRS ports.

FIG. 16 shows another example of DMRS ports allocated to each node according to a proposed method for allocating DMRS ports.

FIG. 17 shows one embodiment of a proposed method for allocating DMRS ports.

FIG. 18 shows an example of DMRS ports allocated to a UE according to a proposed method for receiving a DMRS.

FIG. 19 shows one embodiment of a proposed method for receiving a DMRS.

FIG. 20 is a block diagram showing wireless communication system to implement an embodiment of the present invention.

### DESCRIPTION OF EXEMPLARY EMBODIMENTS

The following technique may be used for various wireless communication systems such as code division multiple access (CDMA), a frequency division multiple access (FDMA), time division multiple access (TDMA), orthogonal frequency division multiple access (OFDMA), single carrier-frequency division multiple access (SC-FDMA), and the like. The CDMA may be implemented as a radio technology such as universal terrestrial radio access (UTRA) or CDMA2000. The TDMA may be implemented as a radio technology such as a global system for mobile communications (GSM)/general packet radio service (GPRS)/enhanced data rates for GSM evolution (EDGE). The OFDMA may be implemented by a radio technology such as institute of electrical and electronics engineers (IEEE) 802.11 (Wi-Fi), IEEE 802.16 (WiMAX), IEEE 802.20, E-UTRA (Evolved UTRA), and the like. IEEE 802.16m, an evolution of IEEE 802.16e, provides backward compatibility with a system based on IEEE 802.16e. The UTRA is part of a universal mobile telecommunications system (UMTS). 3^{rd} generation partnership project (3GPP) long term evolution (LTE) is part of an evolved UMTS (E-UMTS) using the E-UTRA, which employs the OFDMA in downlink and the SC-FDMA in uplink. LTE-advanced (LTE-A) is an evolution of 3GPP LTE.

Hereinafter, for clarification, LTE-A will be largely described, but the technical concept of the present invention is not meant to be limited thereto.

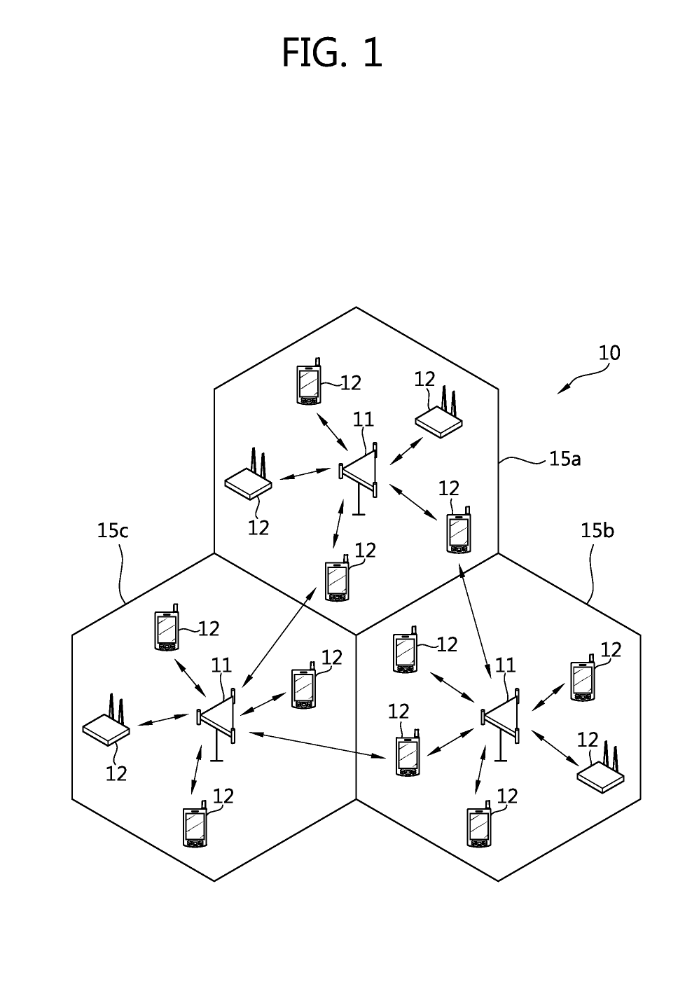

FIG. 1 shows a wireless communication system.

The wireless communication system 10 includes at least one base station (BS) 11. Respective BSs 11 provide a communication service to particular geographical areas 15a, 15b, and 15c (which are generally called cells). Each cell may be divided into a plurality of areas (which are called sectors). A user equipment (UE) 12 may be fixed or mobile and may be referred to by other names such as mobile station (MS), mobile user equipment (MT), user equipment (UT), subscriber station (SS), wireless device, personal digital assistant (PDA), wireless modem, handheld device. The BS 11 generally refers to a fixed station that communicates with the UE 12 and may be called by other names such as evolved-NodeB (eNB), base transceiver system (BTS), access point (AP), etc.

In general, a UE belongs to one cell, and the cell to which a UE belongs is called a serving cell. A BS providing a communication service to the serving cell is called a serving BS. The wireless communication system is a cellular system, so a different cell adjacent to the serving cell exists. The different cell adjacent to the serving cell is called a neighbor cell. A BS providing a communication service to the neighbor cell is called a neighbor BS. The serving cell and the neighbor cell are relatively determined based on a UE.

This technique can be used for downlink or uplink. In general, downlink refers to communication from the BS 11 to the UE 12, and uplink refers to communication from the UE 12 to the BS 11. In downlink, a transmitter may be part of the BS 11 and a receiver may be part of the UE 12. In uplink, a transmitter may be part of the UE 12 and a receiver may be part of the BS 11.

The wireless communication system may be any one of a multiple-input multiple-output (MIMO) system, a multiple-input single-output (MISO) system, a single-input single-output (SISO) system, and a single-input multiple-output (SIMO) system. The MIMO system uses a plurality of transmission antennas and a plurality of reception antennas. The MISO system uses a plurality of transmission antennas and a single reception antenna. The SISO system uses a single transmission antenna and a single reception antenna. The SIMO system uses a single transmission antenna and a plurality of reception antennas. Hereinafter, a transmission antenna refers to a physical or logical antenna used for transmitting a signal or a stream, and a reception antenna refers to a physical or logical antenna used for receiving a signal or a stream.

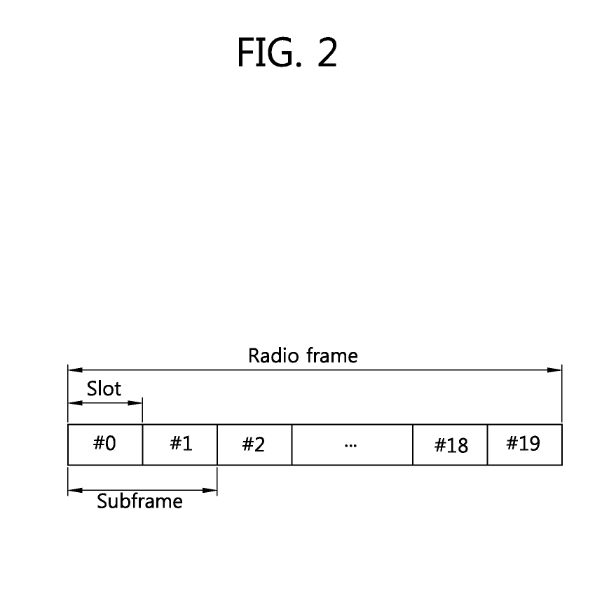

FIG. 2 shows a structure of a radio frame in 3GPP LTE.

It may be referred to Paragraph 5 of “Technical Specification Group Radio Access Network; Evolved Universal Terrestrial Radio Access (E-UTRA); Physical channels and modulation (Release 8)” to 3GPP (3rd generation partnership project) TS 36.211 V8.2.0 (2008-03). Referring to FIG. 2, the radio frame includes 10 subframes, and one subframe includes two slots. The slots in the radio frame are numbered by #0 to #19. A time taken for transmitting one subframe is called a transmission time interval (TTI). The TTI may be a scheduling unit for a data transmission. For example, a radio frame may have a length of 10 ms, a subframe may have a length of 1 ms, and a slot may have a length of 0.5 ms.

One slot includes a plurality of orthogonal frequency division multiplexing (OFDM) symbols in a time domain and a plurality of subcarriers in a frequency domain. Since 3GPP LTE uses OFDMA in downlink, the OFDM symbols are used to express a symbol period. The OFDM symbols may be called by other names depending on a multiple-access scheme. For example, when SC-FDMA is in use as an uplink multi-access scheme, the OFDM symbols may be called SC-FDMA symbols. A resource block (RB), a resource allocation unit, includes a plurality of continuous subcarriers in a slot. The structure of the radio frame is merely an example. Namely, the number of subframes included in a radio frame, the number of slots included in a subframe, or the number of OFDM symbols included in a slot may vary.

3GPP LTE defines that one slot includes seven OFDM symbols in a normal cyclic prefix (CP) and one slot includes six OFDM symbols in an extended CP.

The wireless communication system may be divided into a frequency division duplex (FDD) scheme and a time division duplex (TDD) scheme. According to the FDD scheme, an uplink transmission and a downlink transmission are made at different frequency bands. According to the TDD scheme, an uplink transmission and a downlink transmission are made during different periods of time at the same frequency band. A channel response of the TDD scheme is substantially reciprocal. This means that a downlink channel response and an uplink channel response are almost the same in a given frequency band. Thus, the TDD-based wireless communication system is advantageous in that the downlink channel response can be obtained from the uplink channel response. In the TDD scheme, the entire frequency band is time-divided for uplink and downlink transmissions, so a downlink transmission by the BS and an uplink transmission by the UE cannot be simultaneously performed. In a TDD system in which an uplink transmission and a downlink transmission are discriminated in units of subframes, the uplink transmission and the downlink transmission are performed in different subframes.

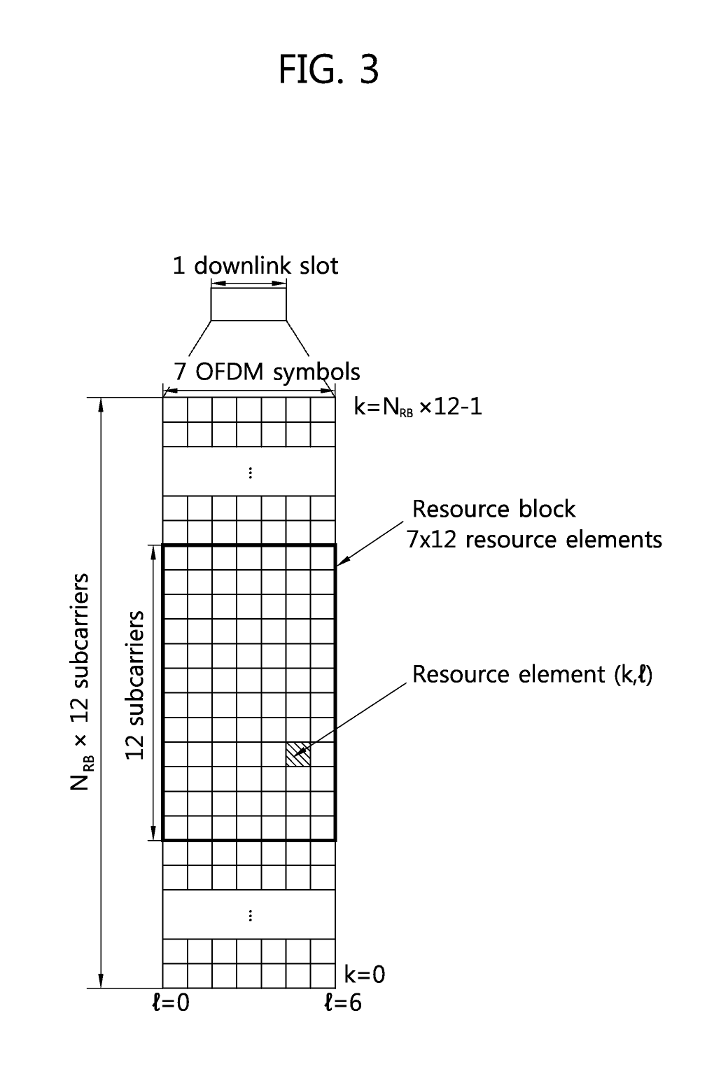

FIG. 3 shows an example of a resource grid of a single downlink slot.

A downlink slot includes a plurality of OFDM symbols in the time domain and N_{RB} number of resource blocks (RBs) in the frequency domain. The N_{RB} number of resource blocks included in the downlink slot is dependent upon a downlink transmission bandwidth set in a cell. For example, in an LTE system, N_{RB} may be any one of 6 to 110. One resource block includes a plurality of subcarriers in the frequency domain. An uplink slot may have the same structure as that of the downlink slot.

Each element on the resource grid is called a resource element. The resource elements on the resource grid can be identified by a pair of indexes (k,l) in the slot. Here, k (k=0, . . . , N_{RB}×12−1) is a subcarrier index in the frequency domain, and l is an OFDM symbol index in the time domain.

Here, it is illustrated that one resource block includes 7×12 resource elements made up of seven OFDM symbols in the time domain and twelve subcarriers in the frequency domain, but the number of OFDM symbols and the number of subcarriers in the resource block are not limited thereto. The number of OFDM symbols and the number of subcarriers may vary depending on the length of a CP, frequency spacing, and the like. For example, in case of a normal CP, the number of OFDM symbols is 7, and in case of an extended CP, the number of OFDM symbols is 6. One of 128, 256, 512, 1024, 1536, and 2048 may be selectively used as the number of subcarriers in one OFDM symbol.

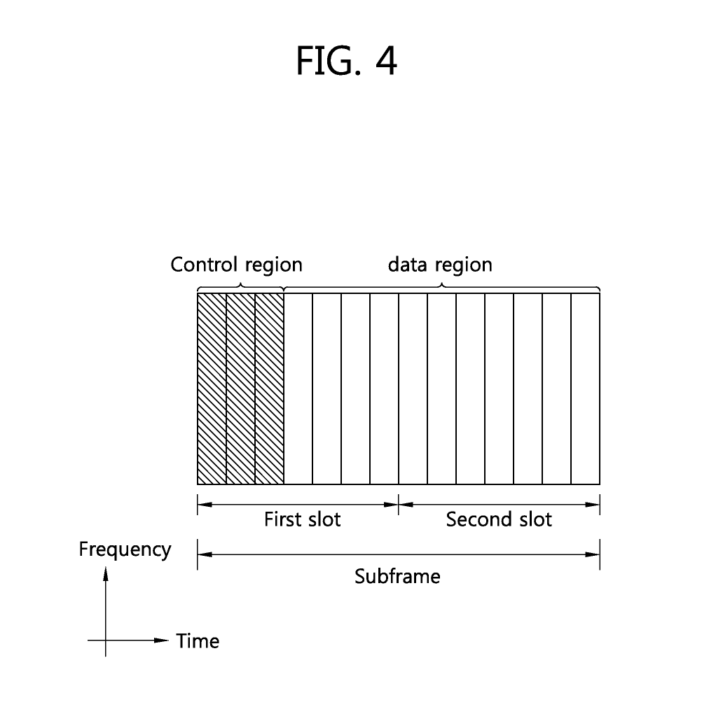

FIG. 4 shows a structure of a downlink subframe.

A downlink subframe includes two slots in the time domain, and each of the slots includes seven OFDM symbols in the normal CP. First three OFDM symbols (maximum four OFDM symbols for a 1.4 MHz bandwidth) of a first slot in the subframe corresponds to a control region to which control channels are allocated, and the other remaining OFDM symbols correspond to a data region to which a physical downlink shared channel (PDSCH) is allocated.

The PDCCH may carry a transmission format and a resource allocation of a downlink shared channel (DL-SCH), resource allocation information of an uplink shared channel (UL-SCH), paging information on a PCH, system information on a DL-SCH, a resource allocation of an higher layer control message such as a random access response transmitted via a PDSCH, a set of transmission power control commands with respect to individual UEs in a certain UE group, an activation of a voice over internet protocol (VoIP), and the like. A plurality of PDCCHs may be transmitted in the control region, and a UE can monitor a plurality of PDCCHs. The PDCCHs are transmitted on one or an aggregation of a plurality of consecutive control channel elements (CCE). The CCE is a logical allocation unit used to provide a coding rate according to the state of a wireless channel. The CCE corresponds to a plurality of resource element groups. The format of the PDCCH and an available number of bits of the PDCCH are determined according to an associative relation between the number of the CCEs and a coding rate provided by the CCEs.

The BS determines a PDCCH format according to a DCI to be transmitted to the UE, and attaches a cyclic redundancy check (CRC) to the DCI. A unique radio network temporary identifier (RNTI) is masked on the CRC according to the owner or the purpose of the PDCCH. In case of a PDCCH for a particular UE, a unique identifier, e.g., a cell-RNTI (C-RNTI), of the UE, may be masked on the CRC. Or, in case of a PDCCH for a paging message, a paging indication identifier, e.g., a paging-RNTI (P-RNTI), may be masked on the CRC. In case of a PDCCH for a system information block (SIB), a system information identifier, e.g., a system information-RNTI (SI-RNTI), may be masked on the CRC. In order to indicate a random access response, i.e., a response to a transmission of a random access preamble of the UE, a random access-RNTI (RA-RNTI) may be masked on the CRC.

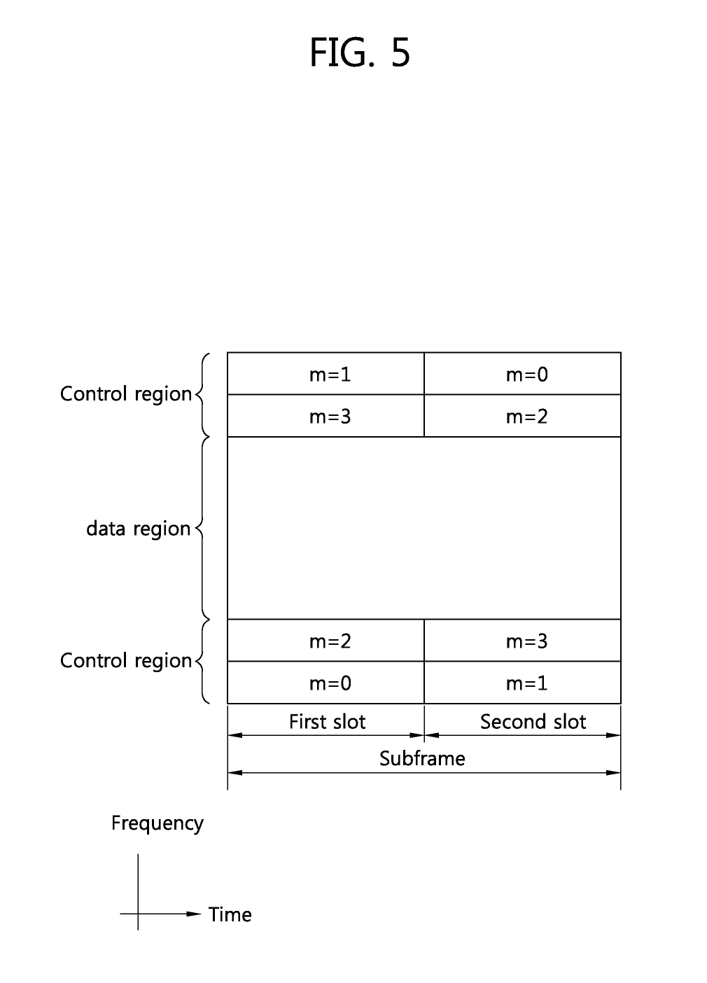

FIG. 5 shows a structure of an uplink subframe.

An uplink subframe may be divided into a control region and a data region in the frequency domain. A physical uplink control channel (PUCCH) for transmitting uplink control information is allocated to the control region. A physical uplink shared channel (PUCCH) for transmitting data is allocated to the data region. When indicated by a higher layer, the UE may support a simultaneous transmission of the PUSCH and the PUCCH.

The PUCCH for a UE is allocated by a pair of RBs in a subframe. The resource blocks belonging to the pair of RBs occupy different subcarriers in first and second slots, respectively. The frequency occupied by the RBs belonging to the pair of RBs is changed based on a slot boundary. This is said that the pair of RBs allocated to the PUCCH is frequency-hopped at the slot boundary. The UE can obtain a frequency diversity gain by transmitting uplink control information through different subcarriers according to time. In FIG. 5, m is a position index indicating the logical frequency domain positions of the pair of RBs allocated to the PUCCH in the subframe.

Uplink control information transmitted on the PUCCH may include a hybrid automatic repeat request (HARQ) acknowledgement/non-acknowledgement (ACK/NACK), a channel quality indicator (CQI) indicating the state of a downlink channel, a scheduling request (SR), and the like.

The PUSCH is mapped to an uplink shared channel (UL-SCH), a transport channel. Uplink data transmitted on the PUSCH may be a transport block, a data block for the UL-SCH transmitted during the TTI. The transport block may be user information. Or, the uplink data may be multiplexed data. The multiplexed data may be data obtained by multiplexing the transport block for the UL-SCH and control information. For example, control information multiplexed to data may include a CQI, a precoding matrix indicator (PMI), an HARQ, a rank indicator (RI), or the like. Or the uplink data may include only control information.

To improve a performance of the wireless communication system, a technique is evolved in a direction of increasing density of nodes capable of accessing to an area around a user. A wireless communication system having nodes with higher density can provide a higher performance through cooperation between the nodes.

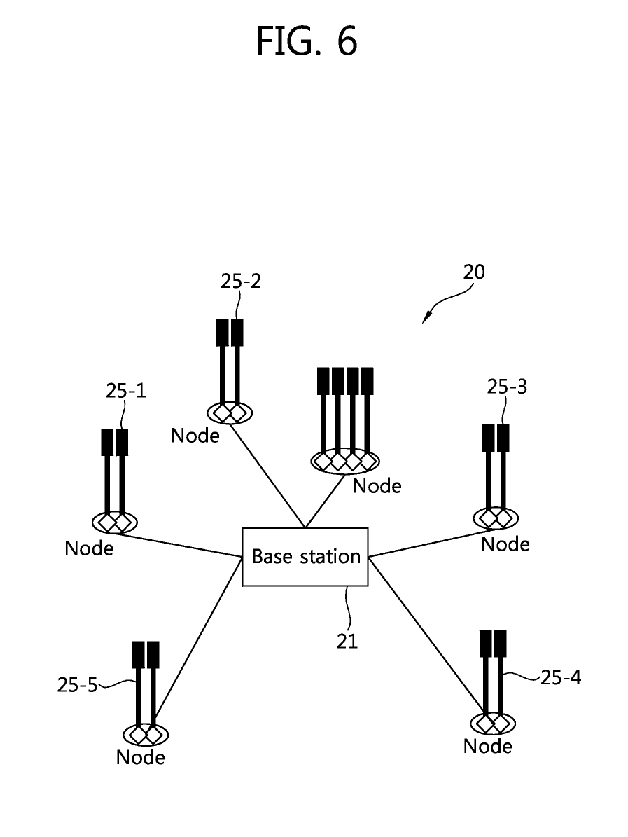

FIG. 6 shows an example of a multi-node system.

Referring to FIG. 6, a multi-node system 20 may consist of one BS 21 and a plurality of nodes 25-1, 25-2, 25-3, 25-4, and 25-5. The plurality of nodes 25-1, 25-2, 25-3, 25-4, and 25-5 may be managed by one BS 21. That is, the plurality of nodes 25-1, 25-2, 25-3, 25-4, and 25-5 operate as if they are a part of one cell. In this case, each of the nodes 25-1, 25-2, 25-3, 25-4, and 25-5 may be allocated a separate node identifier (ID), or may operate as if it is a part of an antenna group without an additional node ID. In this case, the multi-node system 20 of FIG. 6 may be regarded as a distributed multi node system (DMNS) which constitutes one cell.

Alternatively, the plurality of nodes 25-1, 25-2, 25-3, 25-4, and 25-5 may have separate cell IDs and perform a handover (HO) and scheduling of the UE. In this case, the multi-node system 20 of FIG. 6 may be regarded as a multi-cell system. The BS 21 may be a macro cell. Each node may be a femto cell or pico cell having cell coverage smaller than cell coverage of a macro cell. As such, if a plurality of cells is configured in an overlaid manner according to coverage, it may be called a multi-tier network.

In FIG. 6, each of the nodes 25-1, 25-2, 25-3, 25-4, and 25-5 may be any one of a BS, a Node-B, an eNode-B, a pico cell eNB (PeNB), a home eNB (HeNB), a remote radio head (RRH), a relay station (RS) or repeater, and a distributed antenna. At least one antenna may be installed in one node. In addition, the node may be called a point. In the following descriptions, a node implies an antenna group separated by more than a specific interval in a DMNS. That is, it is assumed in the following descriptions that each node implies an RRH in a physical manner. However, the present invention is not limited thereto, and the node may be defined as any antenna group irrespective of a physical interval. For example, the present invention may be applied by considering that a node consisting of horizontal polarized antennas and a node consisting of vertical polarized antennas constitute a BS consisting of a plurality of cross polarized antennas. In addition, the present invention may be applied to a case where each node is a pico cell or femto cell having smaller cell coverage than a macro cell, that is, to a multi-cell system. In the following descriptions, an antenna may be replaced with an antenna port, virtual antenna, antenna group, as well as a physical antenna.

First of all, a reference signal (RS) is described.

In general, a reference signal (RS) is transmitted as a sequence. Any sequence may be used as a sequence used for an RS sequence without particular restrictions. The RS sequence may be a phase shift keying (PSK)-based computer generated sequence. Examples of the PSK include binary phase shift keying (BPSK), quadrature phase shift keying (QPSK), etc. Alternatively, the RS sequence may be a constant amplitude zero auto-correlation (CAZAC) sequence. Examples of the CAZAC sequence include a Zadoff-Chu (ZC)-based sequence, a ZC sequence with cyclic extension, a ZC sequence with truncation, etc. Alternatively, the RS sequence may be a pseudo-random (PN) sequence. Examples of the PN sequence include an m-sequence, a computer generated sequence, a Gold sequence, a Kasami sequence, etc. In addition, the RS sequence may be a cyclically shifted sequence.

A downlink RS may be classified into a cell-specific reference signal (CRS), a multimedia broadcast and multicast single frequency network (MBSFN) reference signal, a UE-specific reference signal, a positioning reference signal (PRS), and a channel state information reference signal (CS-RS). The CRS is an RS transmitted to all UEs in a cell, and is used in channel measurement for a channel quality indicator (CQI) feedback and channel estimation for a PDSCH. The MBSFN reference signal may be transmitted in a subframe allocated for MBSFN transmission. The UE-specific RS is an RS received by a specific UE or a specific UE group in the cell, and may also be called a demodulation reference signal (DMRS). The DMRS is primarily used for data demodulation of a specific UE or a specific UE group. The PRS may be used for location estimation of the UE. The CSI RS is used for channel estimation for a PDSCH of a LTE-A UE. The CSI RS is relatively sparsely deployed in a frequency domain or a time domain, and may be punctured in a data region of a normal subframe or an MBSFN subframe. If required, a channel quality indicator (CQI), a precoding matrix indicator (PMI), a rank indicator (RI), etc., may be reported from the UE through CSI estimation.

A CRS is transmitted from all of downlink subframes within a cell supporting PDSCH transmission. The CRS may be transmitted through antenna ports 0 to 3 and may be defined only for Δf=15 kHz. The CRS may be referred to Section 6.10.1 of 3^{rd} generation partnership project (3GPP) TS 36.211 V10.1.0 (2011-03) “Technical Specification Group Radio Access Network: Evolved Universal Terrestrial Radio Access (E-UTRA): Physical channels and modulation (Release 8)”.

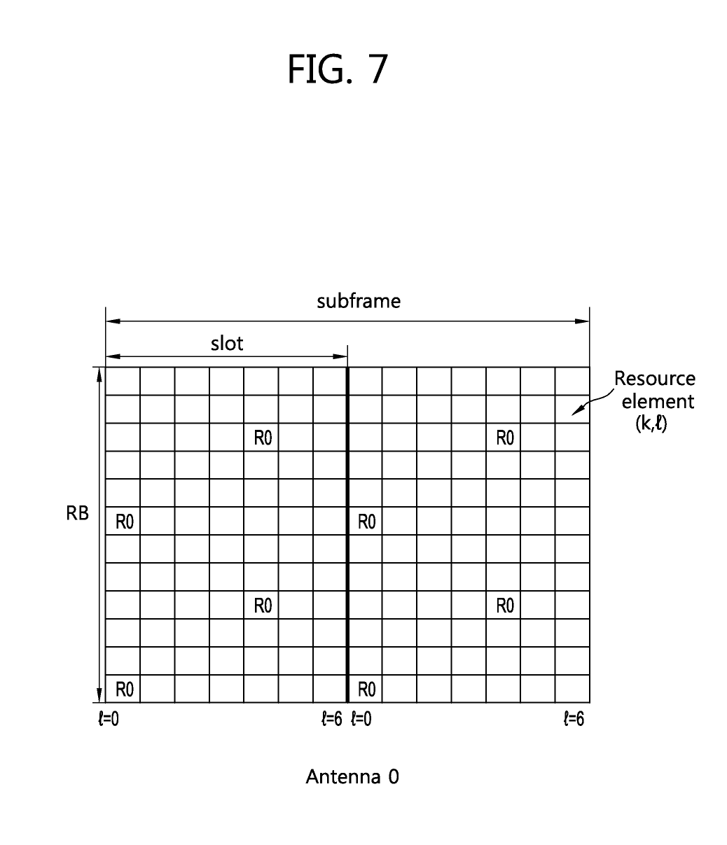

FIGS. 7 to 9 show examples of an RB to which a CRS is mapped.

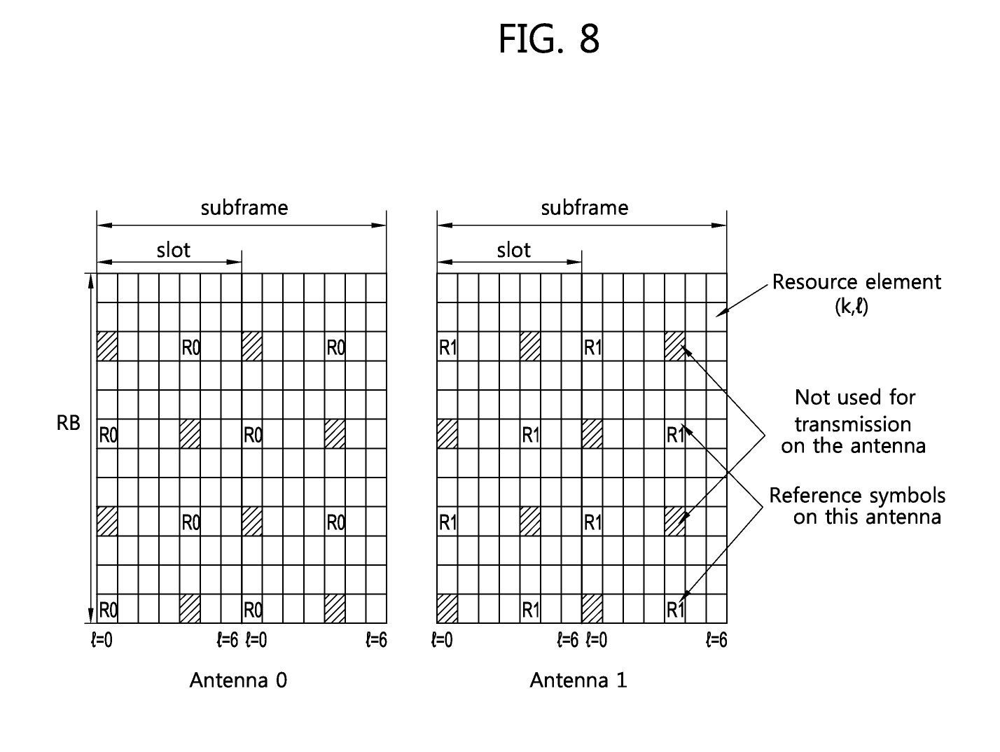

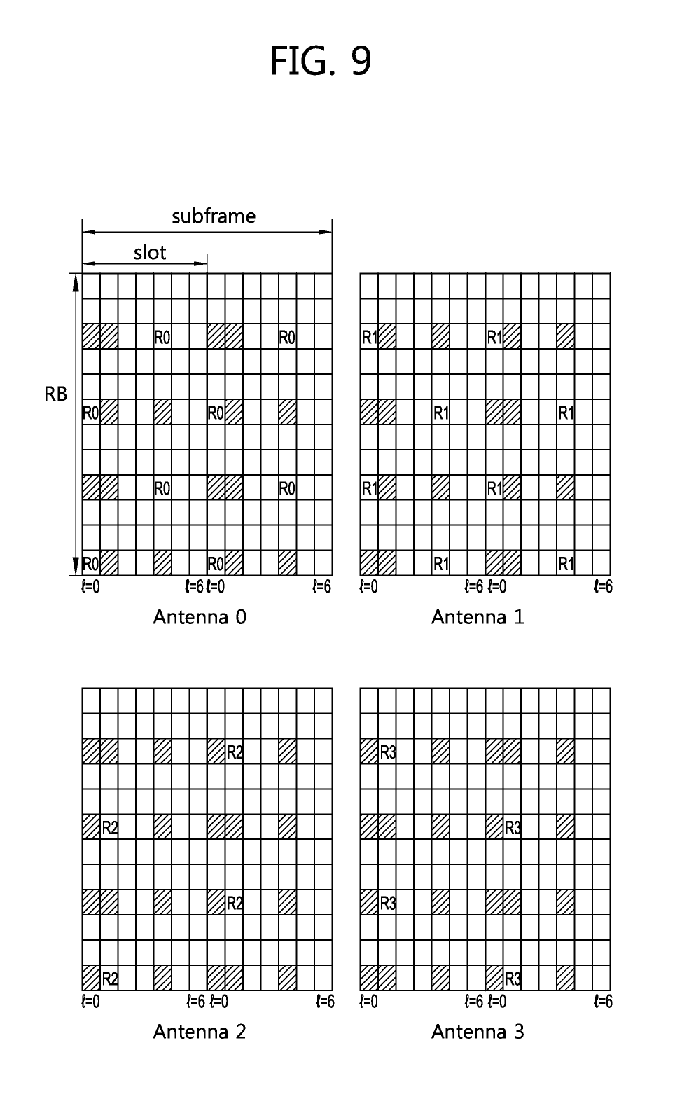

FIG. 7 shows one example of a pattern in which a CRS is mapped to an RB when a base station uses a single antenna port. FIG. 8 shows one example of a pattern in which a CRS is mapped to an RB when a base station uses two antenna ports. FIG. 9 shows one example of a pattern in which a CRS is mapped to an RB when a base station uses four antenna ports. The CRS patterns may be used to support features of the LTE-A. For example, the CRS patterns may be used to support coordinated multi-point (CoMP) transmission/reception technique, spatial multiplexing, etc. Also, the CRS may be used for channel quality measurement, CP detection, time/frequency synchronization, etc.

Referring to FIGS. 7 to 9, in case the base station carries out multiple antenna transmission using a plurality of antenna ports, one resource grid is allocated to each antenna port. ‘R0’ represents a reference signal for a first antenna port. ‘R1’ represents a reference signal for a second antenna port. ‘R2’ represents a reference signal for a third antenna port. ‘R3’ represents a reference signal for a fourth antenna port. Positions of R0 to R3 within a subframe do not overlap with each other. l, representing the position of an OFDM symbol within a slot, may take a value ranging from 0 to 6 in a normal CP. In one OFDM symbol, a reference signal for each antenna port is placed apart by an interval of six subcarriers. The number of R0 and the number of R1 in a subframe are the same to each other while the number of R2 and the number of R3 are the same to each other. The number of R2 or R3 within a subframe is smaller than the number of R0 or R1. A resource element used for a reference signal of one antenna port is not used for a reference signal of another antenna port. This is intended to avoid generating interference among antenna ports.

The CRSs are always transmitted as many as the number of antenna ports regardless of the number of streams. The CRS has a separate reference signal for each antenna port. The frequency domain position and time domain position of the CRS within a subframe are determined regardless of user equipments. The CRS sequence multiplied to the CRS is also generated regardless of user equipments. Therefore, all of user equipments within a cell may receive the CRS. However, it should be noted that the CRS position within a subframe and the CRS sequence may be determined according to cell IDs. The time domain position of the CRS within a subframe may be determined according to an antenna port number and the number of OFDM symbols within a resource block. The frequency domain position of the CRS within a subframe may be determined according to an antenna port number, cell ID, OFDM symbol index (l), a slot number within a radio frame, etc.

The CRS sequence may be applied in unit of OFDM symbol within one subframe. The CRS sequence is varied according to a cell ID, a slot number within one radio frame, OFDM symbol index within the slot, type of CP, etc. Two reference signal subcarriers are involved for each antenna port on one OFDM symbol. In case a subframe includes N_{RB} resource blocks in the frequency domain, the number of reference signal subcarriers for each antenna becomes 2×N_{RB} on one OFDM symbol. Accordingly, a length of a CRS sequence is 2×N_{RB}.

Equation 1 shows an example of a CRS sequence r(m).

$$r ( m ) = \frac{1}{\sqrt{2}} ( 1 - 2 \cdot c ( 2 m ) ) + j \frac{1}{\sqrt{2}} ( 1 - 2 \cdot ( 2 m + 1 ) ) \qquad 〈 Equation 1 〉$$

where m is 0, 1, . . . , 2N_{RB}^{max}−1. 2N_{RB}^{max}−1 is the number of resource blocks corresponding to the maximum bandwidth. For example, in the 3GPP LTE system, 2N_{RB}^{max}−1 is 110. c(i), a PN sequence, is a pseudo-random sequence, which may be defined by the Gold sequence of length 31. Equation 2 shows an example of the gold sequence c(n).

c(n)=(x₁(n+N_{C})+x₂(n+N_{C}))mod 2

x₁(n+31)=(x₁(n+3)+x₁(n))mod 2

x₂(n+31)=(x₂(n+3)+x₂(n+2)+x₂(n+1)+x₂(n))mod 2 <Equation 2>

where N_{C} is 1600. x₁(i) is a first m-sequence, and x₂(i) is a second m-sequence. For example, the first m-sequence or the second m-sequence may be initialized for each OFDM symbol according to a cell ID, slot number within one radio frame, OFDM symbol index within the slot, type of CP, etc.

In the case of a system having bandwidth smaller than 2N_{RB}^{max}, only the specific part of length 2×N_{RB} from a reference signal sequence of length 2N_{RB}^{max} may be used.

Frequency hopping may be applied to the CRS. The period of frequency hopping pattern may be one radio frame (10 ms), and each frequency hopping pattern corresponds to one cell identity group.

At least one downlink subframe may be made of an MBSFN subframes by a higher layer within a radio frame on a carrier supporting PDSCH transmission. Each MBSFN subframe may be divided into a non-MBSFN region and an MBSFN region. The non-MBSFN region may occupy first one or two OFDM symbols within the MBSFN subframe. Transmission in the non-MBSFN region may be carried out based on the same CP as the one used in a first subframe (subframe #0) within a radio frame. The MBSFN region may be defined by OFDM symbols not used for the non-MBSFN region. The MBSFN reference signal is transmitted only when a physical multicast channel (PMCH) is transmitted, which is carried out through an antenna port 4. The MBSFN reference signal may be defined only in an extended CP.

A DMRS supports for PDSCH transmission, and is transmitted on the antenna port p=5, p=, 8 or p=7, 8, . . . , v+6. At this time, v represents the number of layers used for PDSCH transmission. The DMRS is transmitted to one user equipment through any of the antenna ports belonging to a set S, where S={7, 8, 11, 13} or S={9, 10, 12, 14}. The DMRS is defined for demodulation of PDSCH and valid only when transmission of PDSCH is associated with the corresponding antenna port. The DMRS is transmitted only from a RB to which the corresponding PDSCH is mapped. The DMRS, regardless of the antenna port, is not transmitted in a resource element to which either of a physical channel and a physical signal is transmitted. The DMRS may be referred to Section 6.10.3 of the 3^{rd} generation partnership project (3GPP) TS 36.211 V10.1.0 (2011-03) “Technical Specification Group Radio Access Network; Evolved Universal Terrestrial Radio Access (E-UTRA): Physical channels and modulation (Release 8)”.

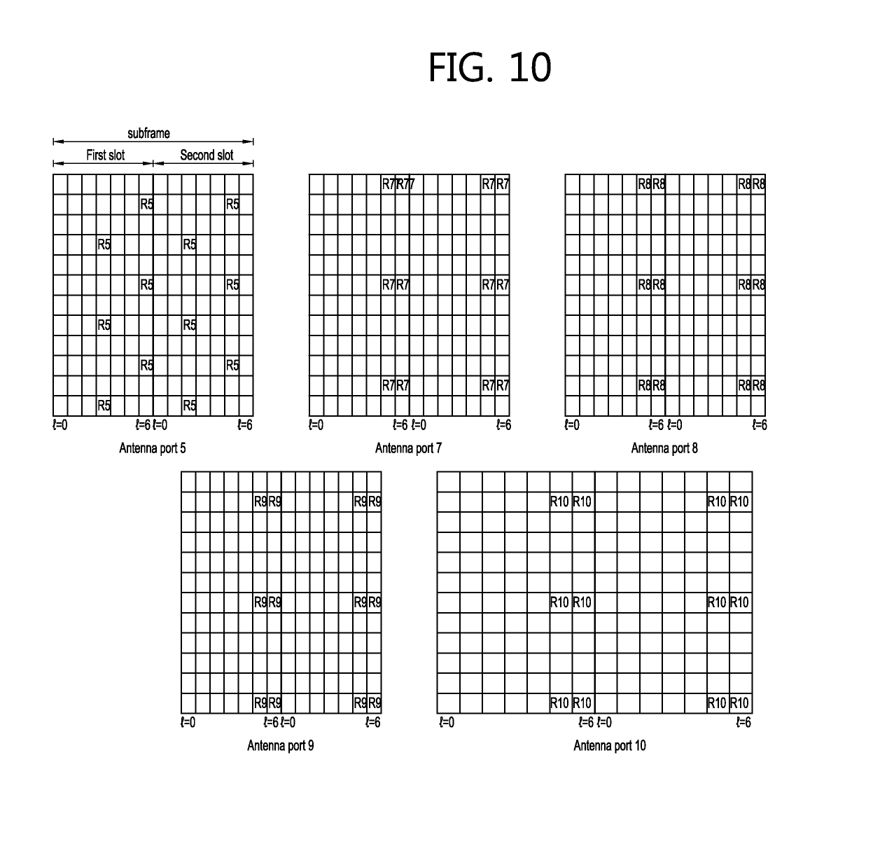

FIG. 10 shows an example of an RB to which a DMRS is mapped.

FIG. 10 shows resource elements used for the DMRS in a normal CP structure. Rₚ denotes resource elements used for DMRS transmission on an antenna port p. For example, R₅ denotes resource elements used for DMRS transmission on an antenna port 5. Also, referring to FIG. 10, the DMRS for an antenna port 7 and 8 are transmitted through resource elements corresponding to a first, sixth, and eleventh subcarriers (subcarrier index 0, 5, 10) of a sixth and seventh OFDM symbol (OFDM symbol index 5, 6) for each slot. The DMRS for the antenna port 7 and 8 may be identified by an orthogonal sequence of length 2. The DMRS for an antenna port 9 and 10 are transmitted through resource elements corresponding to a second, seventh, and twelfth sub-carriers (subcarrier index 1, 6, 11) of a sixth and seventh OFDM symbol (OFDM symbol index 5, 6) for each slot. The DMRS for the antenna port 9 and 10 may be identified by an orthogonal sequence of length 2. Since S={7, 8, 11, 13} or S={9, 10, 12, 14}, the DMRS for the antenna port 11 and 13 are mapped to resource elements to which the DMRS for the antenna port 7 and 8 are mapped, while the DMRS for the antenna port 12 and 14 are mapped to resource elements to which the DMRS for the antenna port 9 and 10 are mapped.

A CSI RS is transmitted through one, two, four, or eight antenna ports. The antenna ports used for each case is p=15, p=15, 16, p=15, . . . , 18, and p=15, . . . , 22, respectively. The CSI RS may be defined only Δf=15 kHz. The CSI RS may be referred to Section 6.10.5 of the 3^{rd} generation partnership project (3GPP) TS 36.211 V10.1.0 (2011-03) “Technical Specification Group Radio Access Network; Evolved Universal Terrestrial Radio Access (E-UTRA): Physical channels and modulation (Release 8)”.

Regarding transmission of the CSI-RS, a maximum of 32 configurations different from each other may be taken into account to reduce inter-cell interference (ICI) in a multi-cell environment, including a heterogeneous network (HetNet) environment. The CSI-RS configuration is varied according to the number of antenna ports within a cell and CP, and neighboring cells may have the most different configurations. Also, the CSI-RS configuration may be divided into two types depending on a frame structure. The two types includes a type applied to both of FDD frame and TDD frame and a type applied only to the TDD frame. A plurality of CSI-RS configurations may be used for one cell. For those user equipments assuming non-zero transmission power, 0 or 1 CSI configuration may be used. For those user equipments assuming zero transmission power, 0 or more CSI configurations may be used. The user equipment does not transmit the CSI-RS in a special subframe of the TDD frame, in a subframe in which transmission of the CSI-RS causes collision with a synchronization signal, a physical broadcast channel (PBCH), and system information block type 1, or in a subframe in which a paging message is transmitted. Also, in the set S, where S={15}, S={15, 16}, S={17, 18}, S={19, 20}, or S={21, 22}, resource elements by which the CSI-RS of one antenna port is transmitted are not used for PDSCH or transmission of the CSI-RS of a different antenna port.

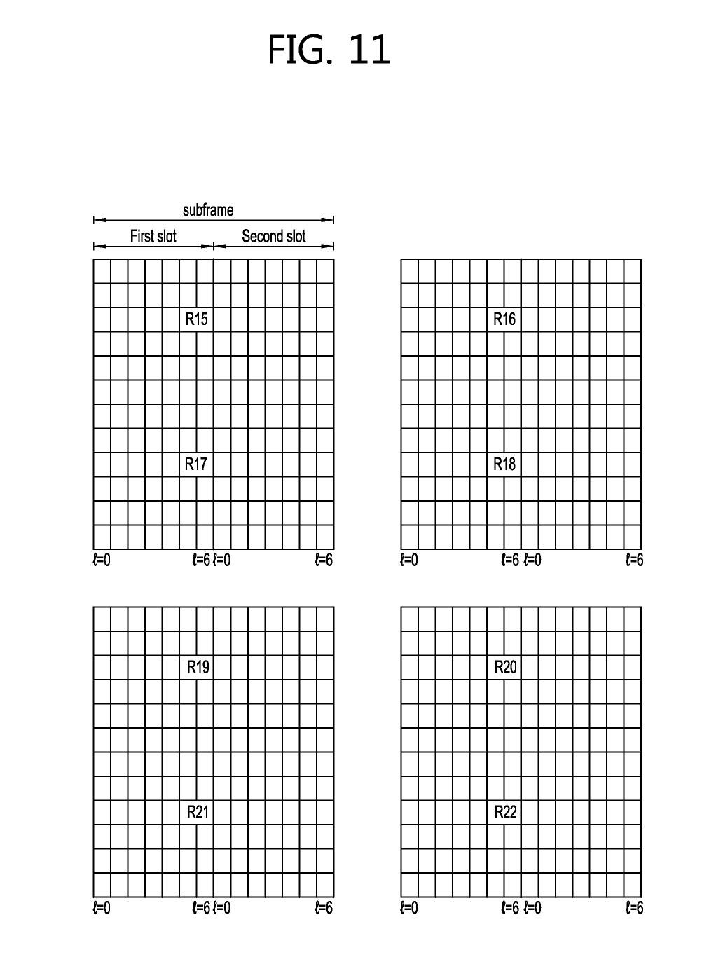

FIG. 11 shows an example of an RB to which a CSI-RS is mapped.

FIG. 11 shows resource elements used for the CSI-RS in a normal CP structure. Rₚ denotes resource elements used for CSI-RS transmission on an antenna port p. Referring to FIG. 11, the CSI-RS for an antenna port 15 and 16 are transmitted through resource elements corresponding to a third subcarrier (subcarrier index 2) of a sixth and seventh OFDM symbol (OFDM symbol index 5, 6) of a first slot. The CSI-RS for an antenna port 17 and 18 is transmitted through resource elements corresponding to a ninth subcarrier (subcarrier index 8) of a sixth and seventh OFDM symbol (OFDM symbol index 5, 6) of the first slot. The CSI-RS for an antenna port 19 and 20 is transmitted through the same resource elements as the CSI-RS for an antenna port 15 and 16 is transmitted. The CSI-RS for an antenna port 21 and 22 is transmitted through the same resource elements as the CSI-RS for an antenna port 17 and 18 is transmitted.

Meanwhile, an RB may be allocated to a PDSCH in a distributed manner or in a continuous manner. The RB indexed sequentially in the frequency domain is called a physical RB (PRB), and the RB obtained by mapping the PRB one more time is called a virtual RB (VRB). Two types of allocation may be supported for allocation of VRBs. A localized type VRB is obtained from one-to-one direct mapping of PRBs indexed sequentially in the frequency domain. A distributed type VRB is obtained by distributed or interleaved mapping of the PRB according to particular rules. To indicate the VRB type, the DCI format 1A, 1B, 1C, and 1D transmitted to allocate the PDSCH through a PDCCH includes a localized/distributed VRB assignment flag. Whether the VRB is a localized type or a distributed type may be determined through the localized/distributed VRB assignment flag.

In what follows, a physical control format indicator channel (PCFICH) is described.

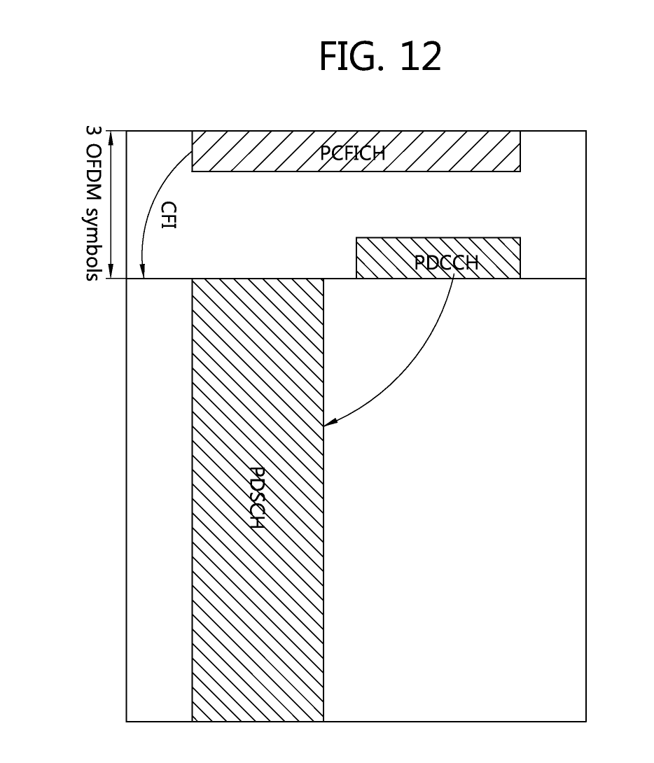

FIG. 12 shows an example where a PCFICH, PDCCH, and PDSCH are mapped to a subframe.

The 3GPP LTE allocates a PDCCH to transmit a downlink control signal intended for controlling user equipments. The region to which PDCCHs of a plurality of user equipments are mapped is called a PDCCH region or a control region. The PCFICH carries information about the number of OFDM symbols used for allocation of the PDCCH within a subframe. The information about the number of OFDM symbols to which the PDCCH is allocated is called a control formation indicator (CFI). All the user equipments within a cell have to search the region to which the PDCCH is allocated, and accordingly, the CIF may be set to a cell-specific value. In general, the control region to which the PDCCH is allocated is allocated to the OFDM symbols at the forefront of a downlink subframe, and the PDCCH may be allocated to a maximum of three OFDM symbols.

Referring to FIG. 12, CIF is set to 3, and accordingly, the PDCCH is allocated to the aforementioned three OFDM symbols within a subframe. The user equipment detects its own PDCCH within the control region and finds its own PDSCH through the detected PDCCH in the corresponding control region.

The PDCCH in the prior art was transmitted by using transmission diversity in a confined region and does not employ various techniques supporting the PDSCH such as beamforming, multi-user multiple-input multiple-output (MU-MIMO), and best band selection. Also, in case a distributed multi-node system is introduced for system performance enhancement, capacity of the PDCCH becomes short if cell IDs of a plurality of nodes or a plurality of RRHs are identical to each other. Therefore, a new control channel may be introduced in addition to the existing PDCCH. In what follows, a control channel newly defined is called an enhanced PDCCH (e-PDCCH). The e-PDCCH may be allocated in a data region rather than the existing control region. As the e-PDCCH is defined, a control signal for each node is transmitted for each user equipment, and the problem of shortage of the PDCCH region can be solved.

As the control region to which the PDCCH is allocated is specified by the PCFICH, a new channel specifying a region to which the e-PDCCH is allocated may be defined. In other words, an enhanced PCFICH (e-PCFICH) may be newly defined, which specifies a region to which the e-PDCCH is allocated. The e-PCFICH may carry part or all of information required for detecting the e-PDCCH. The e-PDCCH may be allocated to a common search space (CSS) within the existing control region or a data region.

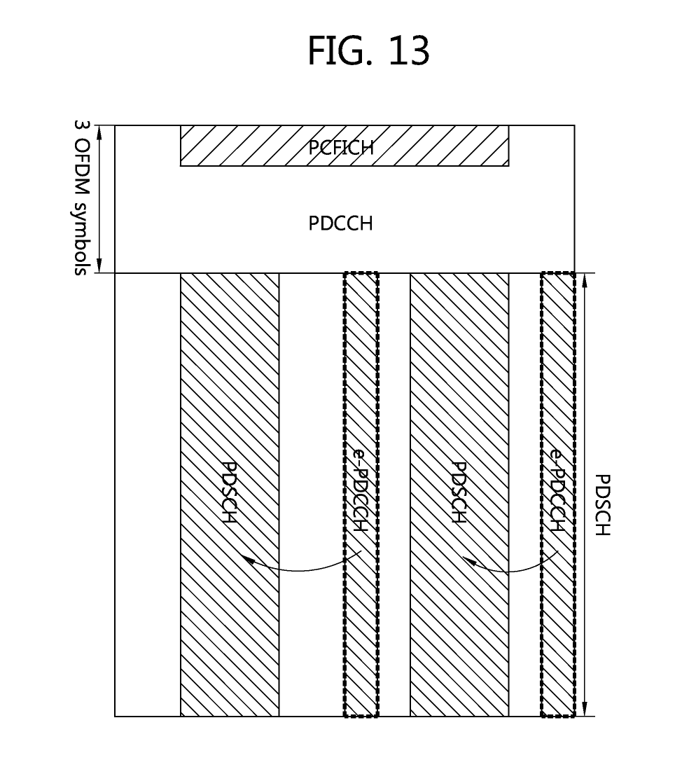

FIG. 13 shows an example of resource allocation through an e-PDCCH.

The e-PDCCH may be allocated to part of a data region rather than the conventional control region. The e-PDCCH is not provided for the existing legacy user equipments, and those user equipments supporting the 3GPP LTE rel-11 (in what follows, they are called rel-11 user equipments) may search for the e-PDCCH. The rel-11 user equipment performs blind decoding for detection of its own e-PDCCH. The information about the minimum region required for detection of the e-PDCCH may be transmitted through a newly defined e-PCFICH or the existing PDCCH. A PDSCH may be scheduled by the e-PDCCH allocated to the data region. A base station may transmit downlink data to each user equipment through the scheduled PDSCH. However, if the number of user equipments connected to each node is increased, the portion of the data region occupied by the e-PDCCH is enlarged. Therefore, the number of blind decoding that has to be performed by the user equipment is also increased, thus increasing degree of complexity.

Currently, antenna ports allocated to the DMRS (hereinafter, DMRS ports) are used sequentially, starting from the antenna port 7 according to the number of layers used for PDSCH transmission. For example, when the number of layers is 2, the DMRS ports correspond to the antenna ports 7 and 8. When the number of layers is 4, the DMRS ports correspond antenna ports 7 to 10. If DMRS ports in a multi-node system including a plurality of nodes are allocated according to the conventional manner, the DMRS ports of UEs connected to the respective nodes will have a high probability of colliding with each other. For example, suppose a plurality of nodes A, B, and C having the same cell ID are located close to each other and each node performs rank-2 transmission to UE a, b, and c, respectively. In case that DMRS ports are allocated according to the conventional manner, there is no other choice but to allocate DMRS ports 7 and 8 of which SCID=0 to the UE a, DMRS ports 7 and 8, DMRS ports 7 and 8 of which SCID=1 to the UE b, and DMRS ports 7 and 8 of which SCID=1 to the UE c in order for the DMRS ports of the UEs connected to the respective nodes to avoid collision as possibly as can be. In this case, since the DMRS ports of the UE a and c collide with each other, a problem occurs in data decoding. To solve the problem, the SCID used together with a DMRS port may have more values in addition to the current values 0 and 1. However, if one DMRS port uses more SCIDs than necessary, performance of channel estimation may become lower than the case of using orthogonal DMRS ports. In other words, the case of using a DMRS port 7 of which SCID=0 and a DMRS port 7 of which SCID=1 within one RB shows lower performance of channel estimation than the case of using DMRS ports 7 and 8 which SCID=0 within one RB. In this sense, the method of increasing the number of SCIDs that can be used for avoiding collision of DMRS ports is not a preferable way of solving the situation. Alternatively, to prevent collision of DMRS ports, the DMRS ports may be allocated by dividing them to individual UEs.

Hereinafter, a proposed method for allocating DMRS ports is described. The proposed method for allocating DMRS ports allocates different DMRS ports to neighboring nodes among a plurality of nodes in a multi-node system. Each node requires as many DMRS ports as the number of layers used, and the DMRS ports can be allocated to neighboring nodes so that the DMRS ports do not overlap with each other.

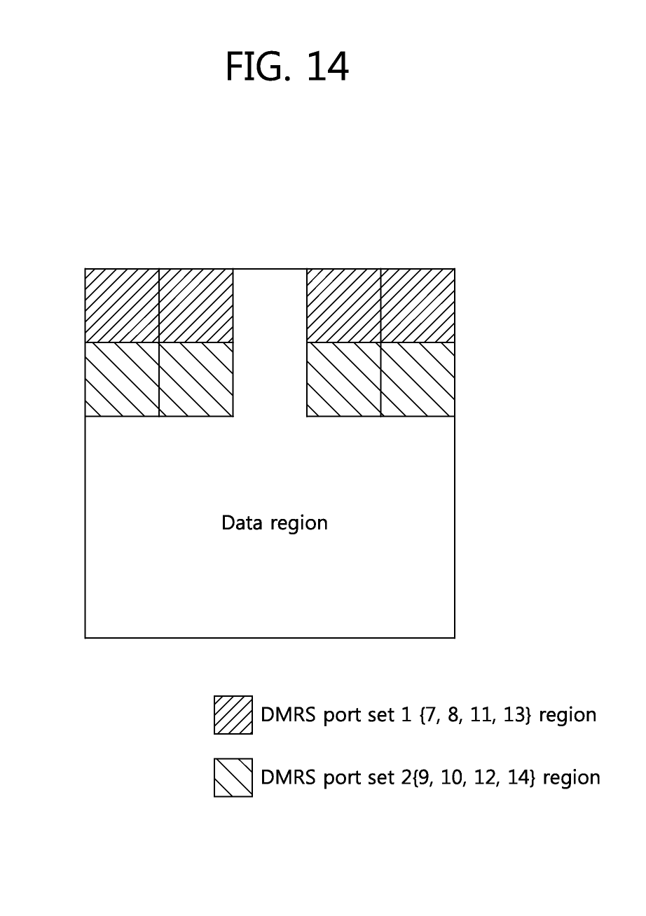

FIG. 14 shows a pattern of which a DMRS is mapped within an RB briefly.

FIG. 14 shows an RB to which the DMRS of FIG. 10 for antenna ports 7 to 10 is mapped briefly. In other words, the upper-left resource elements of FIG. 14 used for transmission of a DMRS corresponds to the resource elements of a first slot used for transmission of a DMRS for the antenna ports 7 to 10 of FIG. 10. Similarly, the upper-right resource elements of FIG. 14 used for transmission of a DMRS corresponds to the resource element of a second slot used for transmission of a DMRS for the antenna ports 7 to 10 of FIG. 10. Except for the antenna port 5, currently, the DMRS is transmitted through the antenna ports 7 to 14. In other words, the DMRS ports correspond to the antenna ports 7 to 14. If a set of DMRS ports mapped to the same resource elements is denoted as a DMRS port set S, S={7, 8, 11, 13} or S={9, 10, 12, 14}. Each DMRS port within a DMRS port set S may be identified by an orthogonal sequence.

Hereinafter, for the convenience of description, a proposed method for allocating DMRS ports is described based on the DMRS pattern of FIG. 14 instead of the DMRS pattern of FIG. 10. Also, a set of resource elements of FIG. 14 to which DMRS ports of {7, 8, 11, 13} are mapped is called a first resource element set, while a set of resource elements to which DMRS ports of {9, 10, 12, 14} are mapped is called a second resource element set.

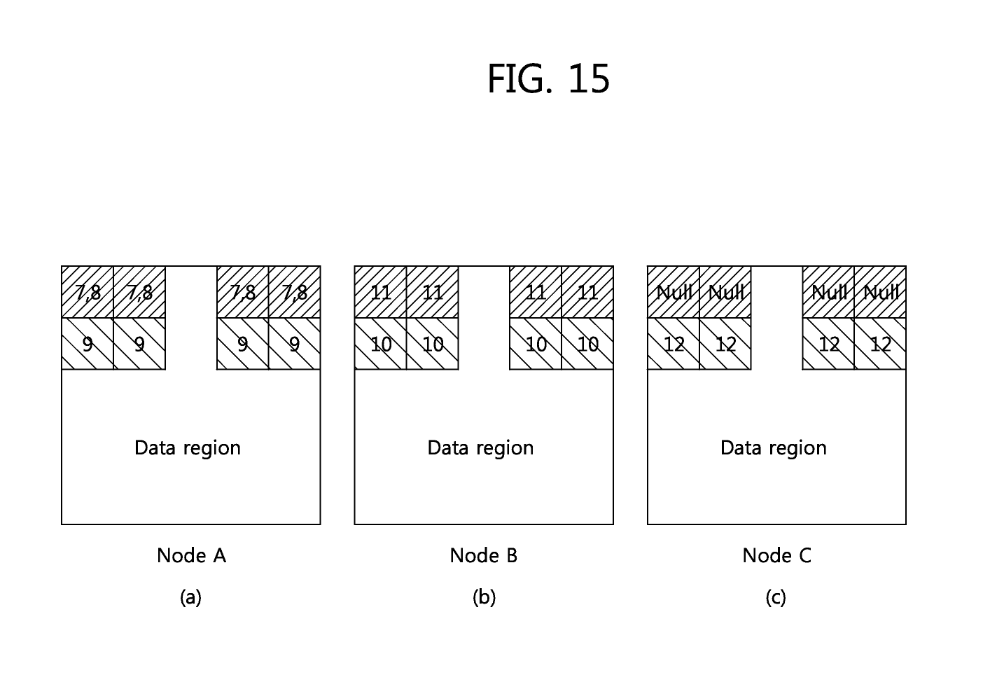

FIG. 15 shows an example of DMRS ports allocated to each node according to a proposed method for allocating DMRS ports.

First, contiguous DMRS ports may be allocated to one node. Accordingly, contiguous DMRS ports may be allocated to a UE when the UE receives data from one node. FIG. 15 assumes that a node A supports rank-3 transmission, a node B supports rank-2 transmission, and a node C supports rank-1 transmission. Therefore, the number of DMRS ports needed by each node is 3, 2, and 1, respectively. At this time, the DMRS ports allocated to the node A may be {7, 8, 9}. The DMRS ports allocated to the node B may be {10, 11}. And, the DMRS port allocated to the node C may be {12}. Among the DMRS ports allocated to the node A, {7, 8} is mapped to the first resource element set while {9} is mapped to the second resource element set. Among the DMRS ports allocated to the node B, {10} is mapped to the second resource element set while {11} is mapped to the first resource element set. The DMRS port {12} allocated to the node C is mapped to the second resource element set. At this time, since the first resource element set is not used for DMRS transmission, the first resource element set may be treated as null, or may be used for transmission of data. The aforementioned treatment of the first resource element set may be predetermined or the base station may inform the UE about the treatment.

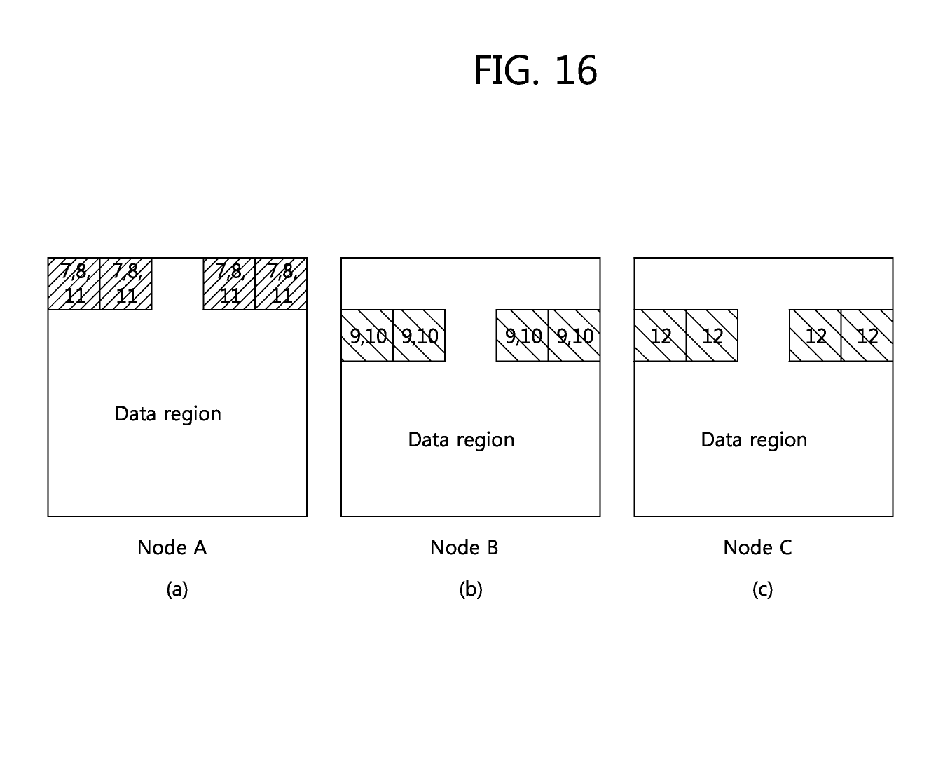

FIG. 16 shows another example of DMRS ports allocated to each node according to a proposed method for allocating DMRS ports.

DMRS ports allocated to one node may be a part of a DMRS port set, and neighboring nodes among a plurality of nodes use DMRS ports each coming from different DMRS port sets. In other words, the DMRS ports allocated to one node may be a subset of {7, 8, 11, 13} or a subset of {9, 10, 12, 14}. FIG. 16 assumes that a node A supports rank-3 transmission, a node B supports rank-2 transmission, and a node C supports rank-1 transmission. Therefore, the number of DMRS ports needed by each node is 3, 2, and 1, respectively. At this time, the DMRS ports allocated to the node A may be {7, 8, 11}. The DMRS ports allocated to the node B may be {9, 10}. And the DMRS port allocated to the node C may be {12}. Alternatively, the DMRS port allocated to the node C may be {5}. The DMRS ports {7, 8, 11} allocated to the node A are all mapped to the first resource element set while the DMRS ports {9, 10} allocated to the node B are all mapped to the second resource element set. The DMRS port {12} allocated to the node C is mapped to the second resource element set. Accordingly, each node is allowed to use only one of the first and the second resource element set for DMRS transmission. The resource element set not used for DMRS transmission may be treated as null, or may be used for transmission of data. The aforementioned treatment of the resource element set may be predetermined or the base station may inform the UE about the treatment. In FIG. 16, the resource element set not used for DMRS transmission is used for transmission of data.

Also, if possible, DMRS ports each belonging to a different DMRS port set may be allocated to one node. Therefore, DMRS ports are multiplexed according to a frequency division multiplexing (FDM) method within the same node, whereas DMRS ports are multiplexed according to a code division multiplexing (CDM) method among different nodes.

Meanwhile, Referring to FIG. 10, resource elements to which the DMRS port 5 is mapped partially overlaps with the second resource element set to which the DMRS ports {9, 10, 12, 14} are mapped. Therefore, the DMRS port 5 is usually used in a different transmission mode from other DMRS ports. However, in the present invention, the DMRS port 5 and the second DMRS port set may be allocated to nodes different from each other. In other words, if the DMRS port 5 and the second DMRS port set are not allocated to one node, the present invention described above may also be applied to the DMRS port 5. For example, as described above, the DMRS port of FIG. 16 allocated to the node C may be {12} within the second DMRS port set or the DMRS port 5.

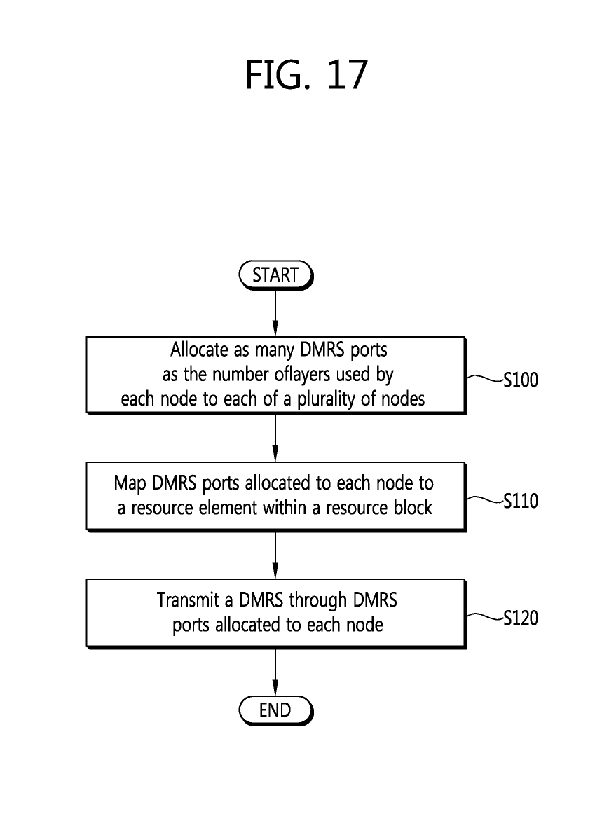

FIG. 17 shows one embodiment of a proposed method for allocating DMRS ports.

In step S100, the base station allocates DMRS ports to each of a plurality of nodes by a number of layers used by each of the plurality of nodes. At this time, the DMRS ports may be allocated as described in FIG. 15 or FIG. 16. In step S110, the base station maps the DMRS ports allocated to each of the plurality of nodes to resource elements within a resource block. In step S120, the base station transmits a DMRS through the DMRS ports allocated to each of the plurality of nodes.

Meanwhile, the UE needs to know DMRS port information before receiving data. Hereinafter, various methods for transmitting DMRS port information and allocating DMRS ports to the UE is described. In the following, the DMRS port 5 is not included in the description, but the proposed invention may still be extended to a method incorporating the DMRS port 5.

1) The UE receives information on a DMRS port set, a start DMRS port within a selected DMRS port set, and the maximum number of layers from the base station, and DMRS ports are allocated to the UE based on the received information. In case that the maximum number of layers is not supported from the start DMRS port to the last DMRS port within the selected DMRS port set, as many DMRS ports as required are allocated additionally from the first DMRS port of the next DMRS port set.

2) The UE receives information on a start DMRS port within a DMRS port set and the maximum number of layers from the base station, and DMRS ports are allocated to the UE based on the received information. In case that the maximum number of layers is not supported from the start DMRS port to the last DMRS port, as many DMRS ports as required are allocated additionally from the first DMRS port.

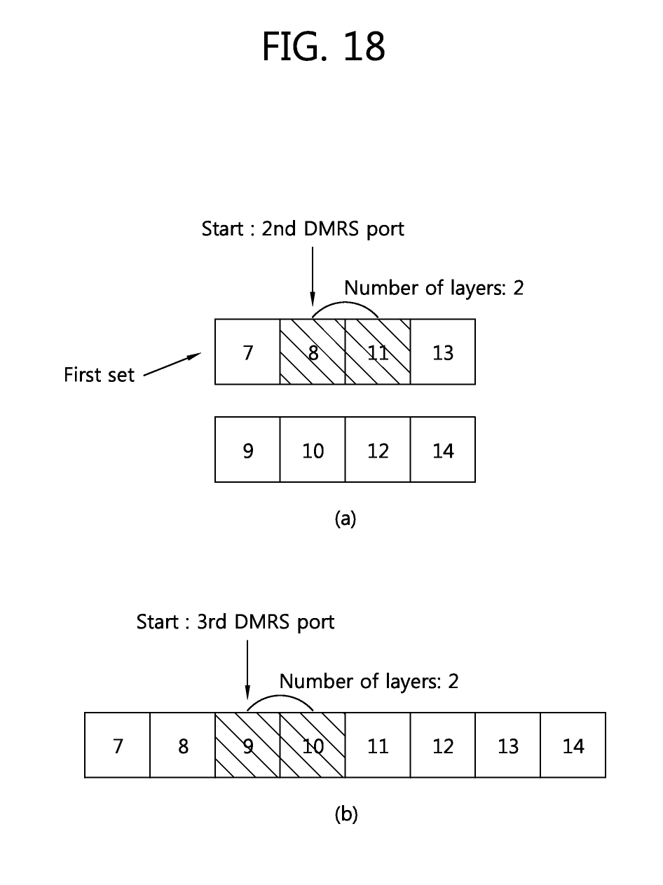

FIG. 18 shows an example of DMRS ports allocated to a UE according to a proposed method for receiving a DMRS.

FIG. 18-(a) shows an example where DMRS ports are allocated to a UE according to 1) described above. A first DMRS port set is selected by DMRS port information transmitted by the base station, and DMRS ports starting from 8, which is a second DMRS port within the first DMRS port set are allocated to the UE. Also, since the maximum number of layers is 2, the DMRS ports allocated to the UE are {8, 11}. If the maximum number of layers is 4, DMRS ports allocated to the UE may correspond to {8, 11, 13} of the first DMRS port set and {9} of a second DMRS port set.

FIG. 18-(b) shows an example where DMRS ports are allocated to a UE according to 2) described above. Based on DMRS port information transmitted by the base station, DMRS ports starting from 9, which is a third DMRS port, are allocated to the UE. Also, since the maximum number of layers is 2, DMRS ports allocated to the UE are {9, 10}.

3) The UE may receive DMRS port information allocated to the UE from the base station in the form of bitmap. In other words, each bit of DMRS port information may specify the DMRS port that can be used by the UE. Each bit of the DMRS port information may indicate availability of DMRS ports 7 to 14 in order. For example, in case that the DMRS port information transmitted by the base station is {11001010}, the DMRS ports that can be used by the UE correspond to {7, 8, 11, 13}. The UE may know through an e-PDCCH that the number of layers of a PDSCH is N, and the UE may decode the PDSCH by using N DMRS ports in order from the first DMRS port among the DMRS ports that can be used by the UE. For example, in case that the number of layers of the PDSCH is 2, the DMRS ports allocated to the UE are {7, 8}. In case the number of layers of the PDSCH is 4, the DMRS ports allocated to the UE are {7, 8, 11, 13}. In the description above, it is assumed that each bit of the DMRS port information indicates whether to use the DMRS ports 7 to 14 in order. However, the DMRS ports corresponding to the respective bits may be changed. For example, each bit of the DMRS port information may indicate whether to use the DMRS ports {7, 8, 11, 13, 9, 10, 12, 14} respectively. The base station may inform the UE about the mapping relationship between bitmapped DMRS port information and each DMRS port.

4) The UE may receive DMRS port information allocated from the base station to the UE for each DMRS port. For example, if it is assumed that each DMRS port information consists of 3 bits and the UE receives DMRS port information of {000, 00, 100, 110}, the DMRS ports that can be used by the UE become {7, 8, 11, 13}. The UE may know through an e-PDCCH that the number of layers of a PDSCH is N, and the UE may decode the PDSCH by using N DMRS ports in order from the first DMRS port among the DMRS ports that can be used by the UE. For example, if the number of layers of the PDSCH is 2, the DMRS ports allocated to the UE are {7, 8}. Alternatively, the UE may decode the PDSCH by using N DMRS ports in order from the DMRS port of the smallest index among the DMRS port that can be used by the UE.

5) The UE receives an index of one DMRS port as DMRS port information from the base station. The UE may decode the PDSCH by using N DMRS ports from the DMRS port having an index received by the UE. The UE may know through an e-PDCCH that the number of layers of the PDSCH is N, and the UE may decode the PDSCH by using N DMRS ports in order from the DMRS port having an index received by the UE. For example, if the UE receives an index 8 from the base station and the number of layers of the PDSCH is 4, the UE may decode the PDSCH by using the DMRS ports {8, 9, 10, 11}. In the description above, it is assumed that the arrangement order of the DMRS ports is {7, 8, 9, 10, 11, 12, 13, 14}, the arrangement order of the DMRS ports may be changed. For example, the arrangement order of the DMRS ports may indicate whether to use {7, 8, 11, 13, 9, 10, 12, 14}. If the received index of a DMRS port is 8 and the number of layers of the PDSCH is 4, the UE may decode the PDSCH by using the DMRS ports {8, 11, 13, 9}. The base station may inform the UE about the arrangement order of the DMRS ports.

6) The UE receives an arrangement order of DMRS ports as DMRS port information from the base station. In case that a PDSCH, the number of layers of which is N, is decoded, the PDSCH may be decoded by using N DMRS ports from a first DMRS port. For example, if the arrangement order of the received DMRS ports is {7, 8, 11, 13, 9, 10, 12, 14} and the number of layers of the PDSCH is 4, the UE may decode the PDSCH by using the DMRS ports {7, 8, 11, 13}.

Meanwhile, the UE may receive an SCID additionally from the base station. The DMRS ports 7 and 8 may have an SCID 0 or 1. In case that the UE receives an SCID additionally from the base station, the SCID is applied only for the DMRS ports 7 and 8, and an SCID of 0 is applied for the DMRS ports 9 to 14. In case that the DMRS port 7 or 8 is used together with at least one DMRS port among the DMRS ports 9 to 14, an SCID of 0 is applied for all the DMRS ports. Also, an SCID may be applied to all of the DMRS ports that can be used.

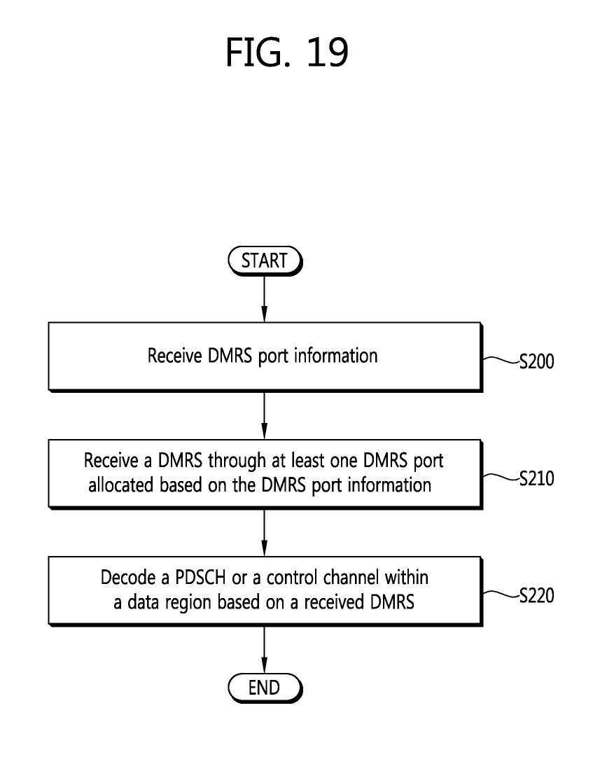

FIG. 19 shows one embodiment of a proposed method for receiving a DMRS.

In step S200, the UE receives DMRS port information from the base station. As described above, DMRS port information may be received in various ways. In step S210, the UE receives a DMRS through at least one DMRS port allocated based on the DMRS port information. In step S220, the UE decodes a PDSCH or a control channel within a data region based on the received DMRS. The control channel within the data region may be an e-PDCCH or an e-PCFICH newly defined for a multi-node system.

In order for the UE to decode a control channel within the data region, a DMRS port allocated according to the method described above may be re-used, or a DMRS port may be received separately.

First, when decoding an e-PDCCH or an e-PCFICH allocated to a common search space within the data region, the UE may decode the e-PDCCH or e-PCFICH by using the DMRS port having the smallest index or the first DMRS port among the DMRS ports allocated to the UE. Likewise, the UE may pre-determine at least one reference signal and decode the e-PDCCH or e-PCFICH based on the pre-determined reference signal. For example, the UE may decode the e-PDCCH or PCFICH by using a CRS port 0 or a DMRS port 7.

Also, when decoding the e-PDCCH allocated to a UE-specific search space within the data region, the UE may use a different DMRS port used for decoding depending on interleaving of the e-PDCCH. In case that the e-PDCCH for each UE is not interleaved, the e-PDCCH may be decoded by using the DMRS port having the smallest index or the first DMRS port among the DMRS ports allocated to the UE. For example, in case that DMRS ports {7, 8, 11, 13} and {9, 10, 12, 14} are allocated to the UE 1 and 2 respectively, both of the UE 1 and 2 may use the DMRS port 7 when decoding the e-PDCCH allocated to the UE-specific search space within the data region, or the UE 1 and 2 may use the DMRS port 7 and 8 respectively. In case that the e-PDCCH of each UE is interleaved and mixed in a plurality of RBs, the e-PDCCH may be decoded by using the DMRS port having the smallest index or the first DMRS port among the DMRS ports allocated to the UE. Similarly, a DMRS port used when the e-PDCCH is interleaved may be allocated separately to the UE. Alternatively, the UE may pre-determine at least one reference signal and decode the e-PDCCH based on the pre-determined reference signal. For example, the UE may decode the e-PDCCH by using the CRS port 0 or the DMRS port 7.

Meanwhile, the UE may receive an SCID additionally from the base station and may decode a control channel within the data region based on the received SCID. The DMRS ports 7 and 8 among the DMRS ports may have an SCID 0 or 1. In case that the UE receives an SCID additionally from the base station, an SCID of 1 is applied to the DMRS ports 7 and 8 while an SCID of 0 is applied to the DMRS ports 9 to 14. In case that the DMRS port 7 or 8 is used together with at least one of the DMRS ports 9 to 14, an SCID of 0 is applied for all of the DMRS ports. Also, an SCID may be applied to all of the DMRS ports that can be used.

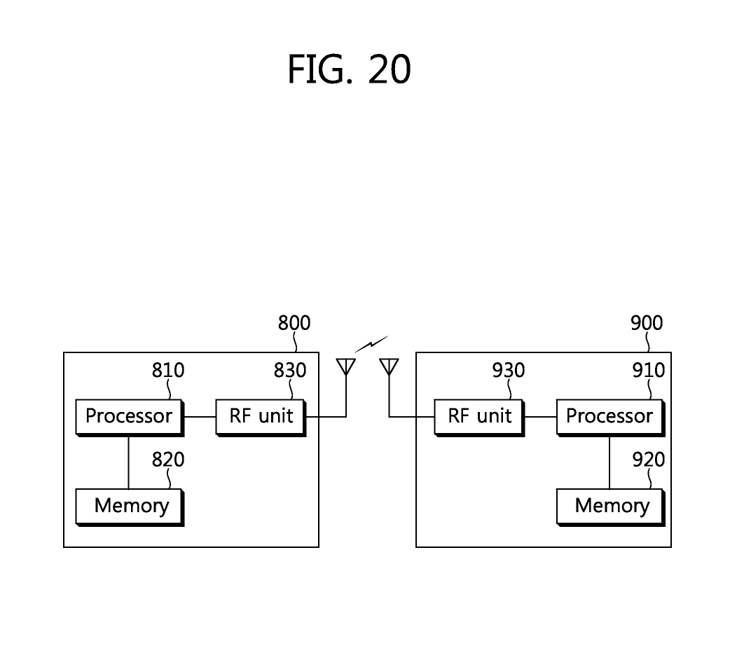

FIG. 20 is a block diagram showing wireless communication system to implement an embodiment of the present invention.

A BS 800 includes a processor 810, a memory 820, and a radio frequency (RF) unit 830. The processor 810 may be configured to implement proposed functions, procedures, and/or methods in this description. Layers of the radio interface protocol may be implemented in the processor 810. The memory 820 is operatively coupled with the processor 810 and stores a variety of information to operate the processor 810. The RF unit 830 is operatively coupled with the processor 810, and transmits and/or receives a radio signal.

A UE 900 may include a processor 910, a memory 920 and a RF unit 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The RF unit 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The RF units 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What has been described above includes examples of the various aspects. It is, of course, not possible to describe every conceivable combination of components or methodologies for purposes of describing the various aspects, but one of ordinary skill in the art may recognize that many further combinations and permutations are possible. Accordingly, the subject specification is intended to embrace all such alternations, modifications and variations that fall within the spirit and scope of the appended claims.

What is claimed is:

1. A method for allocating, by a base station, a demodulation reference signal (DMRS) port in a wireless communication system, the method comprising:
allocating DMRS ports to each of a plurality of nodes by a number of layers used by each of the plurality of nodes;
mapping the DMRS ports allocated to each of the plurality of nodes to resource elements within a resource block (RB); and
transmitting a DMRS through the DMRS ports allocated to each of the plurality of nodes,
wherein the plurality of nodes have the same cell identifier (ID), and
wherein DMRS ports allocated to neighboring nodes among the plurality of nodes do not overlap with each other.

2. The method of claim 1, wherein a DMRS port allocated to a first node among the plurality of nodes is at least one DMRS port included in a first DMRS port set, and
wherein a DMRS port allocated to a second node, adjacent to the first node, among the plurality of nodes is at least one DMRS port included in a second DMRS port set which do not overlap with the first DMRS port set.

3. The method of claim 2, wherein the first DMRS port set is any one of DMRS port sets {7, 8, 11, 13} and {9, 10, 12, 14}, and
wherein the second DMRS port set is the remaining one of the DMRS port sets {7, 8, 11, 13} and {9, 10, 12, 14}.

4. The method of claim 2, wherein the DMRS port allocated to the first node is mapped to a first resource element set within the resource block, and
wherein the DMRS port allocated to the second node is mapped to a second resource element set adjacent to the first resource element set within the resource block.

5. The method of claim 4, wherein the second resource element set within the resource block of the first node and the first resource element set within the resource block of the second node are used for transmission of data or in a null state.

6. The method of claim 1, wherein DMRS ports allocated to one node among the plurality of nodes are contiguous.

7. A method for receiving, by a user equipment (UE), a demodulation reference signal (DMRS) in a wireless communication system, the method comprising:
receiving DMRS port information from a base station;
receiving a DMRS through at least one DMRS port allocated based on the received DMRS port information; and
decoding a physical downlink shared channel (PDSCH) or a control channel within a data region based on the received DMRS.

8. The method of claim 7, wherein the DMRS port information includes a DMRS port set, a start DMRS port within a selected DMRS port set, and the maximum number of layers.

9. The method of claim 7, wherein the DMRS port information includes a start DMRS port and the maximum number of layers.

10. The method of claim 7, wherein the DMRS port information is a bitmap which specifies a DMRS port allocated to the UE by each bit.

11. The method of claim 7, wherein the DMRS port information is an index of one DMRS port.

12. The method of claim 7, wherein the DMRS port information is an arrangement order of DMRS ports.

13. The method of claim 7, further comprising:
receiving scrambling identifier (SCID) information from the base station.

14. The method of claim 7, wherein a control channel within the data region is an enhanced physical downlink control channel (e-PDCCH) carrying a downlink control signal for a multi-node system or an enhanced physical control format indicator channel (e-PCFICH) carrying information about a region to which the e-PDCCH is allocated.

15. A user equipment (UE) configured to receive a demodulation reference signal (DMRS) in a wireless communication system, the UE comprising:
a radio frequency (RF) unit for transmitting or receiving a radio signal; and
a processor connected to the RF unit, and configured to:
receive DMRS port information from a base station,
receive a DMRS through at least one DMRS port allocated based on the received DMRS port information, and
decode a physical downlink shared channel (PDSCH) or a control channel within a data region based on the received DMRS.
